(19) United States
(12) Patent Application Publication
(10) Pub. No.: US 2019/0222872 A1
(43) Pub. Date: Jul. 18, 2019

(54) PLAYOUT BUFFERING IN A LIVE CONTENT DISTRIBUTION SYSTEM

(71) Applicant: NET INSIGHT INTELLECTUAL PROPERTY AB, Stockholm (SE)

(72) Inventors: Christer BOHM, Nacka (SE); Per LINDGREN, Strangnas (SE); Anders CEDRONIUS, Alvsjo (SE); Ted OLSSON, Stockholm (SE)

(73) Assignee: NET INSIGHT INTELLECTUAL PROPERTY AB, Stockholm (SE)

(21) Appl. No.: 16/336,978

(22) PCT Filed: Sep. 29, 2017
(86) PCT No.: PCT/EP2017/074816

§ 371 Date: Mar. 27, 2019

(30) Foreign Application Priority Data
Sep. 30, 2016 (SE) 1651289-9

(51) Int. Cl. H04N 21/234; H04N 21/6405; H04N 21/6408; H04N 21/231; H04L 29/06; H04L 1/18

(52) U.S. Cl. CPC H04N 21/23406; H04N 21/6405; H04L 1/1874; H04N 21/23106; H04L 65/4076; H04N 21/6408

(57) ABSTRACT

There is provided a method and corresponding node and system for playout buffering and retransmission which can handle Over-The-Top (OTT) and Video-On-Demand (VOD) distribution to a large number of client devices, e.g. a server serving a number of client devices with e.g. the same TV-channel. The presented method comprises transmitting a data stream DS from a server 101 to at least two client devices 151-153, where a predetermined portion of client shared data of the data stream is buffered in a shared buffer. Upon receiving per client requests for retransmission of data from the client devices, requested data is retrieved from the shared buffer and retransmitted to the requesting client device. The method further comprises removing buffered data from said shared buffer based on if a time of interest for the buffered data has passed. The inventive concept is applicable in distribution of e.g. media data as in typical OTT and VOD, which is transported over unicast. Optionally, media data is distributed over multicast but with per client requests for retransmissions.

### TECHNICAL FIELD

The present invention relates to the field of communication network systems for node-to-node transmission of data, and more particularly to a method for playout buffering and retransmission in a distribution system for live content over the Internet.

### BACKGROUND OF THE INVENTION

For Over-The-Top (OTT) distribution and Video-On-Demand (VOD) systems, normally one server streams a video stream to a large number of clients. This means that the server needs to hold a per client portion of data to handle retransmission in the case that data is lost in the communication between the server and the client. This is true whether the distribution and retransmission is handled by using TCP, or using UDP with an application layer retransmission technology. A problem connected to this is that buffering of the per client portion of data to handle retransmission scales with the number of clients served.

In a server, the performance is to a high extent affected by how large memory bandwidth the server central processor unit (CPU) can achieve towards the memory system. The memory system in a server consists of a primary memory and disk, where the primary memory is smaller and faster. To achieve higher performance smaller memories may be utilized, which are even faster than the primary memory, and which are located closer to the CPU. These memories are called cache. In addition, the cache can also be organized in levels, Level 1 cache (small and very fast access), Level 2 cache (bigger and slower than the Level 1 cache), etc. Each cache memory is normally divided into an instruction cache (holding the “program”) and a data cache (holding the data being processed). So if a program and its corresponding data is in the cache the execution will be magnitudes faster than when executed on e.g. the disk.

For distribution of media content in the case of OTT and VOD, the distributed data is associated with each client device it is being sent to, and this type of distribution thus consumes a large amount of data making it likely to be stored/processed in a lower level of the memory hierarchy, i.e., Level 2 cache or primary memory.

Also, when data is stored per client, incoming data that is to be sent to many clients needs to be copied to each client. Copying data many times also slows down the performance of the server.

Data forwarding from one input interface board to an outgoing does not mean that the data needs to be copied. Data that is not processed is direct memory accessed (DMA'ed) to the memory while header information which is processed enters the data cache. It is therefore in the interest of the implementation to avoid processing as much data as possible to avoid copying and that the cache becomes “full”.

### SUMMARY OF THE INVENTION

It would be advantageous to provide an at least improved and reliable method for playout buffering and retransmission which can handle OTT and VOD distribution to a large number of client devices, which method consumes less resources than the prior art solutions. This object is achieved by a method according to the present inventive concept as defined in claim 1.

Thus, in a first aspect of the present inventive concept, there is provided a method for transmitting a data stream from a server to at least two client devices comprising for at least one outgoing data stream: transmitting the data stream to the at least two client devices, and buffering a predetermined portion of the data stream in a shared buffer. Upon receiving per client requests for retransmission of data from the at least two client devices, retransmitting requested data from the shared buffer. The inventive concept is applicable in distribution of e.g. media data as in typical OTT and VOD, which is transported over unicast. Optionally, media data is distributed over multicast but with per client requests for retransmissions. For a server serving a number of client devices with the same TV-channel, in contrast to the prior art operation with TCP which provides buffering for retransmission per client, according to the present inventive concept the outgoing data stream is buffered once in a shared buffer for the many client device data streams, and the same buffered data is then utilized to serve retransmission for all client devices.

According to the invention, the method further comprises removing buffered data from the shared buffer based on if the time of interest for the buffered data has passed. This may be indicated with a timer or by utilizing time stamps distributed in the data stream to indicate if the time of interest of buffered data has passed. Buffered data is kept a predetermined time (indicating that data is too old to be valid anymore), particularly in the case of video where the time of displaying the data stream has passed, or until it is likely that all devices have received the data, i.e. when no requests for retransmission of lost packets are detected within the time of interest. This manner the clients do not have to send an ACK to acknowledge that they have received the data. Instead a timer indicating that the time of interest for the data has passed is utilized. The timer based solution significantly reduces the upstream traffic from the devices to the server since messages are only sent upstream in case of lost data downstream.

According to an embodiment of the method, it further comprises prior to the step of buffering identifying client device shared data of the data stream. By identifying client shared data in the data packets of the outgoing data stream at least candidate data for being buffered in the shared buffer is identified. The client device shared data will comprise payload data, e.g. the media content of the TV-channel, but may also include client shared header data, timestamps, subtitles, application data like tweets or social interactive data, etc.

According to an embodiment of the method, the step of buffering is performed on payload data of the data stream (and/or header data that is common for the clients). In applications where FEC or any other payload data application is used, the whole data packet will be processed and will therefore enter the processors cache memory. However, when the payload is not processed, the payload can remain in the primary memory or some lower level cache memory but the header information which needs to be processed will therefore enter the cache.

According to an embodiment of the method, per client header information is processed only once for each client, and processed per client data is buffered in said shared buffer. When sending a packet the header is constructed and it is possible to point to the shared buffer of payload data. The header will be unique for each destination but the payload data is the same. The shared buffer of the payload data can be in the cache or the primary memory. In each way it is automatically transferred to the interface card when send instruction is being issued. In the present inventive concept the payload data is stored once and is used for all clients thereby saving primary memory, avoiding copying and potential cache misses. This allows for the server to handle a significantly larger number of client network interfaces.

According to an embodiment of the method, the outgoing data stream is transported over unicast or over multicast with individual client requests for retransmissions which is advantageous. In the shared buffer the data is stored with a, for all clients, common sequence number. So when a client requests a retransmission the server finds the payload data using the sequence number. The method with one shared buffer for several client devices can thus be used both for unicast and multicast applications.

According to an embodiment of the method, when the method is concerned with multicast distribution of video, i.e. video distribution using multicast, the step of retransmitting is performed as unicast or multicast transmission. For multicast distribution of video, it can be an option to send retransmissions as unicast or multicast. This choice can depend on several aspects.

According to an embodiment of the method, unicast or multicast transmission is selected based on if there is a network installation or subnetwork (for example a stadium installation with native layer 1 or layer 2 (L1/L2) multicast. The retransmission of a packet has the same cost if it is uni- or multicast meaning that if the data is requested more than once, multicast is beneficial.

According to an embodiment of the method, if the multicast transmission uses L1/L2 multicast in at least one subnetwork but not between subnetworks, multicast transmission is selected. It might be beneficial to use multicast if the requests for retransmission from clients are in the same subnetwork but if it is different subnetworks not.

According to an embodiment of the method, if a predetermined threshold number of request are received from a multiple of client devices, multicast transmission is selected. If a large number of requests are issued it is beneficial to select multicast transmission of the retransmission.

According to an embodiment of the method, payload data is buffered in a dedicated memory instead of a cache or a primary memory of the server. This is advantageous if a payload data application is utilized, e.g. FEC, which in a similar manner as when performing checksum calculations on the packets, this is performed on the whole payload and on the network interface card.

According to an embodiment of the method, further comprising constructing packets comprising requested data from the shared buffer and per client (individual client) information selected from a list of header unique destination data.

According to an embodiment of the method, removing buffered data may be performed based on received acknowledge from all client devices.

According to a second aspect of the inventive concept, there is provided a node in a communication network comprising means for performing a method according to the present inventive concept. It may further comprise means for transmitting the outgoing data stream, e.g. a transmitter.

In a communication system arranged for node to node communication, the node comprises a memory storing computer-readable instructions, and a processor configured to execute the computer-readable instructions to a method according to the present inventive concept. Further, according to a third aspect of the inventive concept, there is provided a non-transitory computer readable storage medium storing computer-readable instructions executable by a processor to cause the processor to perform the method presented herein.

Embodiments of the present inventive method are preferably implemented in a distribution, media content provider, or communication system by means of software modules for signaling and providing data transport in form of software, a Field-Programmable Gate Array (FPGA), an Application Specific Integrated Circuit (ASIC) or other suitable device or programmable unit, adapted to perform the method of the present invention, an implementation in a cloud service or virtualized machine (not shown in diagrams). The software module and/or data-transport module may be integrated in a node comprising suitable processing means and memory means, or may be implemented in an external device comprising suitable processing means and memory means, and which is arranged for interconnection with an existing node. The node is preferably arranged at an edge node, e.g. in communication with a streaming edge server, or is integrated in/or constitutes a streaming edge server.

Further objectives of, features of, and advantages with, the present invention will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

The above will be better understood through the following illustrative and non-limiting detailed description of preferred embodiments of the present invention, with reference to the appended drawings, where the same reference numerals will be used for similar elements, and wherein:

FIG. 1 is a schematic block diagram illustrating a server-client communication system in which embodiments of a method and node according to the present inventive concept is employed;

FIGS. 2a-2c are schematic flow charts illustrating embodiments of a method according to the present inventive concept; and

FIGS. 3 to 6 are schematic block diagrams illustrating a server-client communication system in which embodiments of a method according to the present inventive concept is employed.

All the figures are schematic, not necessarily to scale, and generally only show parts which are necessary in order to elucidate the invention, wherein other parts may be omitted or merely suggested.

### DETAILED DESCRIPTION OF PREFERRED EMBODIMENTS

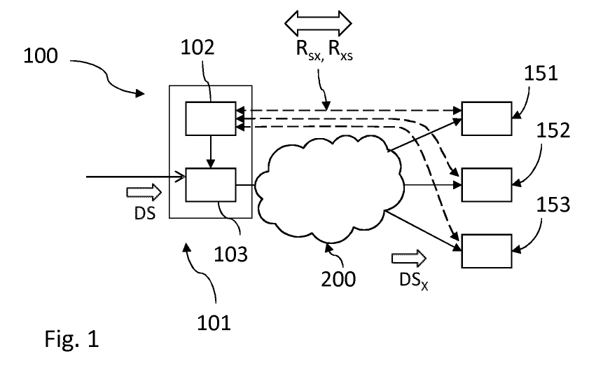

Referring now to FIG. 1, which is a block diagram schematically illustrating a communication network system 100 of e.g. IP type for live distribution of media content, in view of which aspects of the present inventive concept will be described. A server 101 (which may be a streaming edge server, or playout server, receiving data from an ingress server (not shown) of a distribution system (not shown), is arranged for providing media content to one or more recipients or client devices 151, 152, 153. The media content is sent as a data stream DS using unicast or multicast via respective communication links over a network 200, and is typically provided as a stream of contiguous packets, which may have different size, and may represent different types of packets with some header or trailer portion identifying the type.

In the distribution network system data transmission of the data stream DS from the ingress device to the client devices 151, 152, 153 may involve transmitting e.g. video content or other media content in the form of video packets (multi cast video packets), and e.g. audio packets. The data stream DS is received at the streaming edge server (playout server), here embodied by the server 101, from which the multiple client devices 151, 152, 153 located at different viewer locations request media content to display. The media content is distributed to the client devices 151, 152, 153 in separate data streams DS₁, DS₂, and DS₃ (illustrated as DSₓ in FIG. 1) over a respective communication link, which may be provided over a computer network (e.g. a LAN a WAN, the Internet), a wireless network (e.g. a cellular data network), or some combination of these network types (illustrated as the secondary network 200 in FIG. 1). Each client device 151, 152, 153 comprises means for processing received media content and to select media content to play. The primary distribution network and the secondary network 200 do not need to be dedicated networks but can be shared with other services.

The client devices 151, 152, 153, connecting to the server to request live media content may be e.g. different versions of smart phones, IP connectable TV-sets or computers from different manufacturers and thus have different prestanda with respect to clock speed/frequencies, tolerances etc. The client devices thus need to be synchronized to provide simultaneous playout, i.e. to provide a synchronized playout time, of the packets of their respective instances of the media stream DSₓ. The data stream for transmission DSₓ is represented as a sequence of data packets representing a contiguous stream of information, with each data packet comprising a set of payload information representative of a segment of the stream of information corresponding thereto.

In order to handle missing packets and other types of errors, communication and distribution systems employ various techniques to handle erroneously received information. The client devices may correct the erroneously received information amongst other techniques by retransmission techniques, which enable the erroneously received information to be retransmitted to the receiver, i.e. client device, for example, by using automatic retransmission request (ARQ) or forward error correction (FEC) techniques. FEC techniques include, for example, convolutional or block coding of the data prior to modulation. FEC coding involves representing a certain number of data bits or blocks of data using a certain (greater) number of code bits or code blocks, thereby adding redundancy which permits correction of certain errors.

If there are lost packets during data transmission, any client(s) experiencing missing packets will request retransmission (RT) of the lost packets from the server 101. In addition to retransmission if there is FEC information available, the clients can either attempt to recover lost packets by FEC correction and then by retransmission, or first by retransmission and then by FEC correction on the newly transmitted data.

According to an embodiment of the invention the distribution system further comprises a control device for handling retransmission of media content to the client devices, which may be embodied by a separate control server 102, either arranged separately from and in communication with the (streaming) server 101, or integrated in the server 101 as illustrated in FIG. 1. When integrated in the server 101, the control device 102 is preferably a software module and/or data-transport module. The server 101 (or the control device) further comprises a shared buffer 102 which may make part of the memory resources of the server, or may be a dedicated memory device.

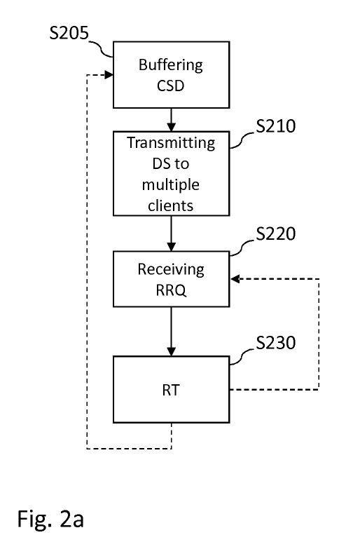

Embodiments of a method for transmitting a data stream from a server to at least two client devices which comprises providing packet loss recovery for transmission of a data stream DSₓ in a packet-based network according to the present inventive concept will now be described with reference to FIGS. 2a-2c, and the exemplifying distribution system as described above with reference to FIG. 1. For illustrative purposes, the data stream for transmission DSₓ is represented as a sequence of data packets of a contiguous stream of data, with each data packet comprising a set of payload information corresponding to one or more specific data types.

In FIG. 2a, in a step S205, a predetermined portion of client shared data (CSD) of a data stream DS to be transmitted from the server 101 to a plurality of client devices 151, 152, 153 which are connected to the server is buffered in the shared buffer 102. In an example a specific amount of payload data of the data stream is buffered in the shared buffer. The data stream DS is transmitted to the client devices (step S210). Client devices that experience data loss in the distribution may send requests for retransmission of lost packets (RRQ), which are received by the server (step S220). Finally, requested packets are retrieved from the shared buffer 102 and retransmitted RT to the client devices (step S230).

According to an embodiment of the method, see FIG. 2b, it further comprises discarding buffered data from the shared buffer based on received acknowledge from all client devices that a specific buffered data has been received by the client device, or based on a timer indicating that the time of interest for the buffered data has passed (step S240) thus avoiding sending acknowledgements consuming upstream communication capacity.

According to an embodiments of the method, as illustrated in FIG. 2c, before transmission of the data stream DS to client devices, a list of unique header data (UHD) for each client device may be created (step S202) and buffered in the shared buffer or in other memory of the server 101. Preferably, the UHD for each client device is constructed as a new device is connected to the server. As previously mentioned, the server 101 may be a streaming edge server, or playout server, receiving data from an ingress server (not shown) of a distribution system. As an incoming data stream DS containing client shared data (CDS) is received at the server 101 (step S203), the received data stream is analyzed and (predetermined) client shared data (CSD) is identified (step S204). The client shared data CSD, e.g. payload containing media content to be displayed is subsequently buffered in the shared buffer (step S205). Optionally a list of shared header data (SHD) for all client device is identified and created in step S204, which SHD may be buffered in the shared buffer (step S205). Packets to be transmitted in the data stream DS are constructed from respective unique header data UHD and client shared data CSD retrieved from the shared buffer (steps S207 and S209) and transmitted to the client devices (step S210). As the server receives requests for retransmissions RRQ, step S220, requested client shared data and UHD corresponding to the client device that made the RRQ are retrieved from the shared buffer and the list of UHD (step S207) from which data packets for retransmission of lost data are constructed (step S209, and subsequently retransmitted to the client devices, step S230).

The method steps of the present method as illustrated in FIGS. 2a-2c may be combined, or conditionally excluded and are not necessarily presented in a required order as is schematically illustrated by the dashed boxes and arrows in the Figs.

The outgoing data stream (step S220) may be transmitted using unicast or multicast with per client requests for retransmissions. When using multicast distribution of the outgoing data stream DS (step 220), e.g. video, the step of retransmission (step S230) may be performed as unicast or multicast transmission.

According to an embodiment of the method, as illustrated with dashed box S229 in FIG. 2c, the step of retransmission may be selected to be either unicast of multicast in a step S229. Several parameters may be utilized to decide how to make the decision on unicast or multicast transmission. In a first scenario, unicast or multicast transmission is selected based on if there is a stadium installation with native layer 1 or layer 2, “L1/L2”, multicast. The retransmission of a packet has the same cost if it is uni- or multicast meaning that if the data is requested more than once, multicast is beneficial. If the multicast uses L1/L2 multicast in at least one region but not between regions multicast transmission is selected. It might be beneficial to use multicast if the request is in the same region but if it is different regions not. In a second scenario, the unicast or multicast decision is based on if a predetermined threshold number of request is received from a multiple of client devices, in which case multicast transmission is selected which is beneficial.

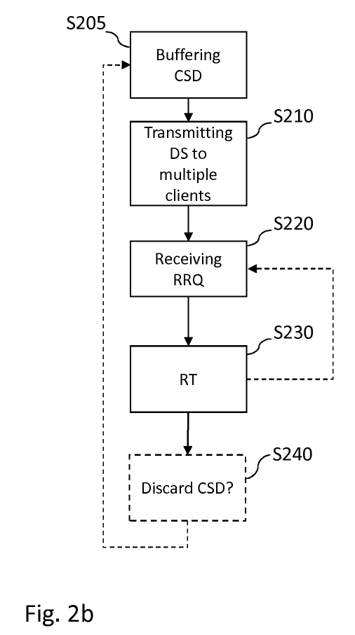

Referring now to FIG. 3, a server 101 (or optionally the dedicated control server 102) as previously described herein further comprises a network interface card (NIC) 105 arranged for communication with a number of client devices, 151-153. According to a method of the present inventive concept, client shared data CSD, e.g. payload data P1-P5 containing media content to be presented in client devices 151-153 is buffered in a shared buffer 501 in the server 101 (control device 102). The payload data P1-P5 in the shared buffer is stored with a, for all client devices, common sequence number. As a client requests a retransmission RRQ the server locates the payload data using the sequence number. The method with one shared buffer for several client devices can thus be used both for unicast and multicast applications. Further, a list of unique header data UHD 500 (here illustrated as H151, H152, and H153) is buffered/stored in the server 101 (or alternatively a control server 102). When the data stream DS is distributed to the client devices 151-153, CSD and UHD are retrieved from the shared buffer and the list of UHD to the NIC 105 as illustrated by means of dashed arrows in FIG. 3. In the NIC, packets 10a and 10b are constructed and subsequently transferred to the respective client devices 151 and 152. Each of the packets 10a and 10b contain the same payload (P1 in the exemplifying illustration) but their own unique header data, H151 and H152, respectively.

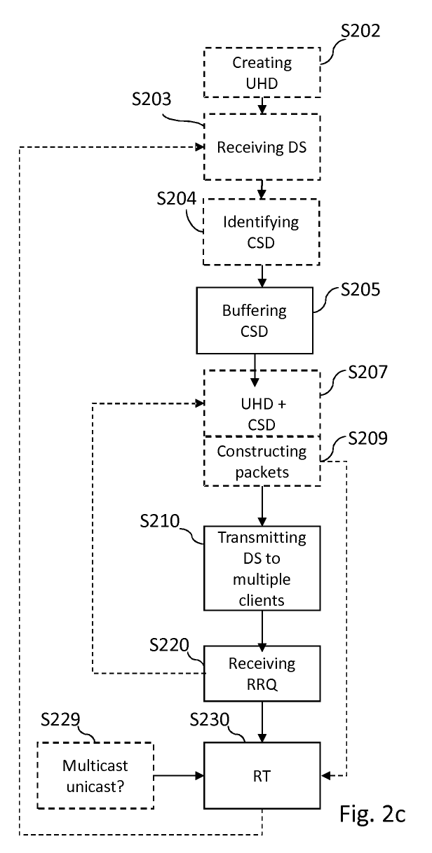

When a client requests a retransmission, as illustrated in FIG. 4, in which a client device 151 sends an RRQ for the missing data P3, RRQ:P3, to the NIC 105 of the server 101/102, UHD H151 is retrieved from the list of unique header data 500, as payload P3 from the shared buffer 501, a packet 10c is constructed containing the UHD H151 and the CSD P3, and the packet is then retransmitted to the client device either as unicast or multicast.

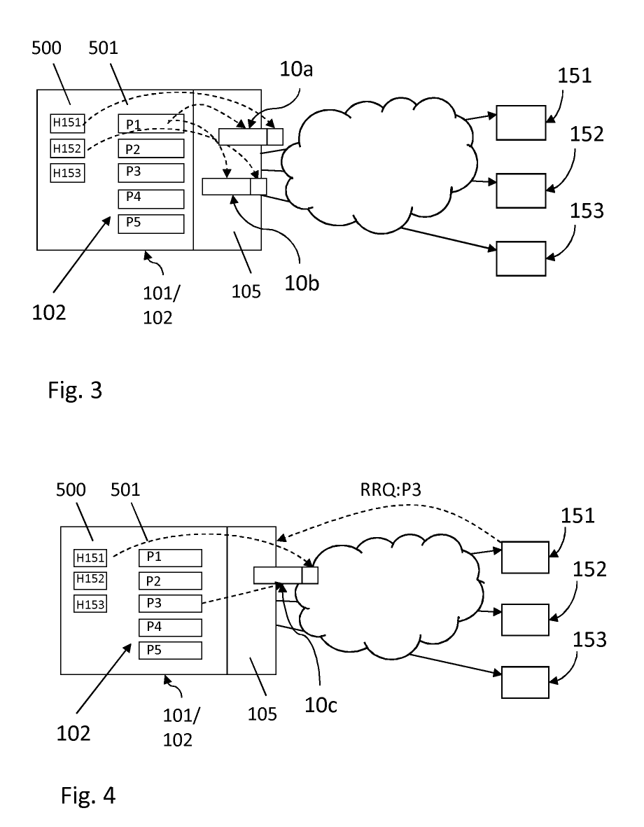

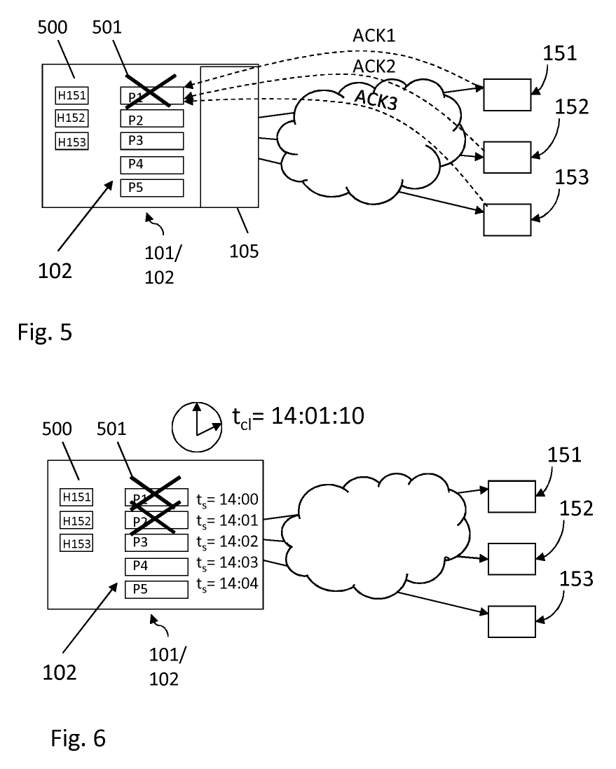

When buffered CDS in the shared buffer 501 is no longer useful, according to an embodiment of the method as illustrated in FIGS. 5 and 6, CDS data is discarded. In FIG. 5, acknowledgement signals ACK1, ACK2, ACK3 illustrated with dashed arrows, are sent from each of the client devices, when the payload data P1 is successfully received. Since all client devices have successfully received a specific CDS, it may be discarded from the shared buffer 501, as illustrated with a cross over payload P1. This is preferably combined with a timer or other timing information, like the one described below with reference to FIG. 6, to decide if data is still useful or if it is too old, and thus should be discarded from the shared buffer 501.

In yet another embodiment, as illustrated in FIG. 6, non useful CSD are discarded based on a current time/time stamps tₛ of a local clock t_{cl} of the server 101 or a timer indicating that the time of interest for the buffered data has passed. Buffered data is kept a predetermined time, as long as data is not too old to be valid anymore, particularly in the case of video where the time of presentation of the content of the data stream has passed. In the illustrative example, the time of the local clock t_{cl}=14:01:10, and any payload with a time stamp tₛ for displaying the media content is too old, and can be discarded from the shared buffer 501.

Although illustrative embodiments of the present inventive concept have been described herein with reference to the accompanying drawing, it is to be understood that the invention is not limited to that precise embodiments thereof, but that various changes and modifications may be effected therein by one skilled in the art without department from the scope or spirit of this invention.

1. A method for transmitting a data stream from a server to at least two client devices comprising:
for at least one outgoing data stream:
transmitting said data stream to said at least two client devices; and
buffering a predetermined portion of said data stream in a shared buffer;
wherein upon receiving per client requests for retransmission of data from at least one of said at least two client devices:
retransmitting requested data from said shared buffer, and
removing buffered data from said shared buffer based on if a time of interest for the buffered data has passed.

2. A method according to claim 1, wherein said step of buffering is performed on payload data of said data stream and/or client shared header data.

3. A method according to claim 1, wherein said outgoing data stream is transported using unicast or multicast with individual client requests for retransmissions.

4. A method according to claim 1, wherein when said method is concerned with video distribution using multicast, said step of retransmitting is performed as unicast or multicast transmission.

5. A method according to claim 4, wherein unicast- or multicast transmission is selected based on if there is a network installation with native layer 1 or layer 2, L1/L2, multicast.

6. A method according to claim 5, wherein if said multicast transmission uses L1/L2 multicast in at least one subnetwork but not between subnetworks, multicast transmission is selected if there are requests for retransmission from client devices connected to the different subnetworks.

7. A method according to claim 5, wherein if a predetermined threshold number of request are received from a multiple of client devices, multicast transmission is selected.

8. A method according to claim 1, wherein payload data is buffered in a dedicated memory instead of a cache or a primary memory of said server.

9. A method according to claim 1, further comprising constructing packets comprising requested data from said shared buffer and per client information selected from a list of header unique destination data.

10. A method according to claim 1, wherein said step of removing buffered data is performed based on received acknowledge from all client devices.

11. A method according to claim 1, wherein a timer or time stamps distributed in the data stream is utilized for deciding if the time of interest of buffered data has passed.

12. A node in a communication system arranged for node to node communication, the node comprising: a memory storing computer-readable instructions, and a processor configured to execute the computer-readable instructions to a method according to claim 1.

13. A node, according to claim 11, further comprising means for transmitting said outgoing data stream.

14. A non-transitory computer readable storage medium storing computer-readable instructions executable by a processor to cause the processor to perform the method according to claim 1.
